(19) United States
(12) Patent Application Publication
(10) Pub. No.: US 2008/0163440 A1
(43) Pub. Date: Jul. 10, 2008

(54) Medical instrument pre cleaner

(76) Inventor: Angelica Denise Ruelas, Chandler, AZ (US)

Correspondence Address: Angelica D. Ruelas, 2281 E. Honeysuckle Pl, Chandler, AZ, 85249, US

(21) Appl. No.: 11/650,603

(22) Filed: Jan. 8, 2007

(51) Int. Cl. B08B 1/00; A46B 13/02

(52) U.S. Cl. 15/21.1; 15/104.92

(57) ABSTRACT

A device designed for simplified pre cleaning of instruments used in the medical and dental fields. The device consists of a container housing multiple abrasion elements suspended within the container in close proximity to each other and cleaning fluid. When an instrument is pushed into the abrasion elements it is scrubbed from multiple surfaces, while the cleaning fluid softens and captures debris being removed from the instrument. A motorized version enhances scrubbing action. A lid on the device minimizes the spread of debris around the work station.

### CROSS REFERENCE

Not Applicable

### STATEMENT REGARDING FEDERALLY SPONSORED RESEARCH

Not Applicable

### REFERENCE TO SEQUENCE LISTING, A TABLE, OR A COMPUTER PROGRAM LISTING COMPACT DISC APPENDIX

Not Applicable

### FIELD OF INVENTION

This, invention pertains to the cleaning of instruments used in the medical and dental fields.

### DESCRIPTION OF PRIOR ART

Medical and dental instruments are typically cleaned in a series of steps starting with a hand scrubbing using a bristle brush or similar device to remove heavy debris followed by ultrasonic cleaning and sterilization. The hand cleaning portion of the process requires the use of two hands and spreads debris around the work station that must also be cleaned.

### SUMMARY OF THE INVENTION

The present invention consists of a container, abrasion elements, a suspension element and a lid. The container is of sufficient size and depth to house the abrasion elements and cleaning fluid, and heavy enough to remain in place without holding it when an instrument is engaged with the abrasion elements. The abrasion elements are suspended off the bottom of the container and held in correct position to each other by a frame or by attachment directly to the container. The abrasion elements consists of multiple bristle heads held in close proximity to each other so that when an instrument is pushed into the abrasion elements that it is scrubbed from all sides. The device is used by pushing the instrument into the abrasion elements in a reciprocating manor, as the instrument is being scrubbed, fluid held within the container helps soften debris and capture it as it is removed from the instrument. A lid with a small entry port is placed over the top of the container to help prevent fluid and debris loss during scrubbing. A motor with associated gearing, switches, housings, linkages, and wiring can be added to the device to manipulate movement of the abrasion elements, further reducing effort by the user. The current invention reduces the problems of prior art by providing one handed operation, increased scrubbing efficiency and reduced work station clean up.

### BRIEF DESCRIPTION OF DRAWINGS

FIG. 1 Depicts an overhead view of a MEDICAL INSTRUMENT PRE CLEANER in a manual configuration.

FIG. 2 Depicts an overhead view of a MEDICAL INSTRUMENT PRE CLEANER in a motorized configuration.

FIG. 3 Depicts an overhead view of a MEDICAL INSTRUMENT PRE CLEANER with a cover.

FIG. 4 Depicts a transparent side view of a MEDICAL INSTRUMENT PRE CLEANER in both manual an motorized configurations.

### DESCRIPTION OF THE PREFERRED EMBODIMENT

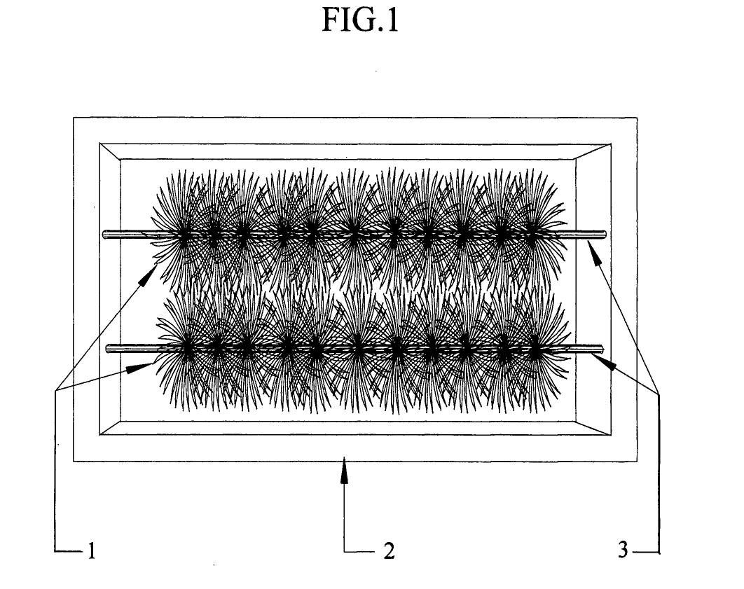

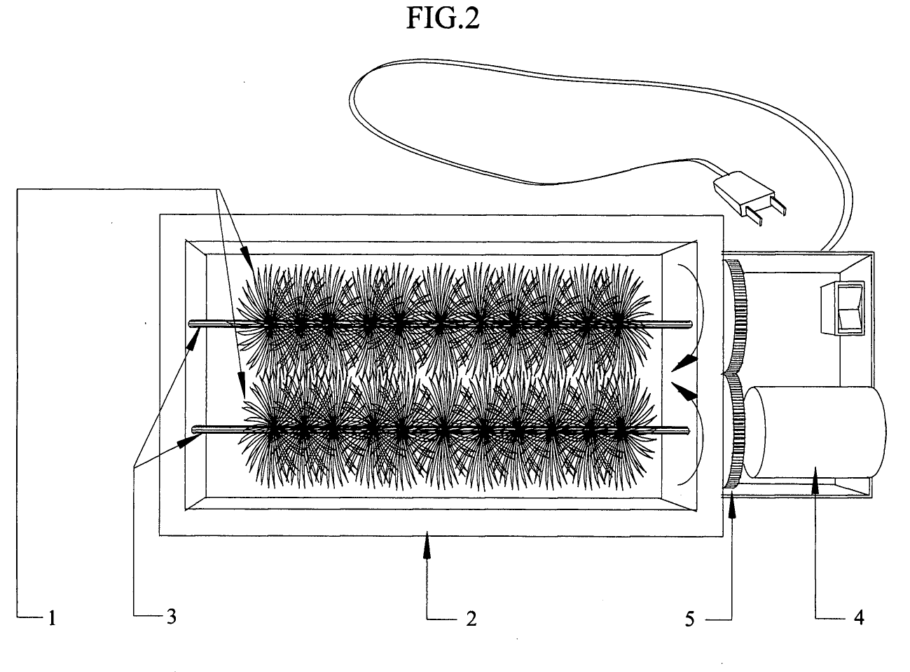

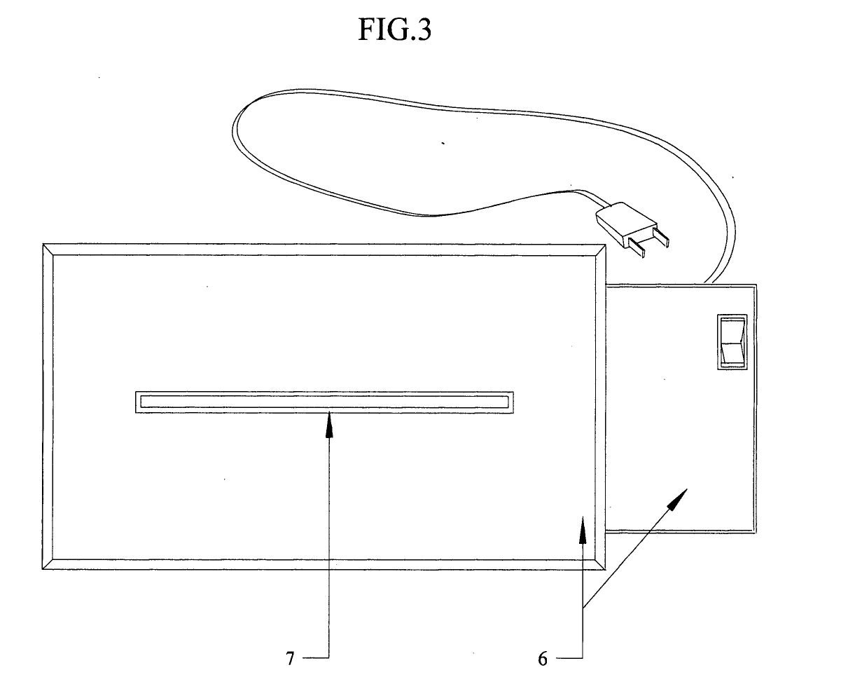

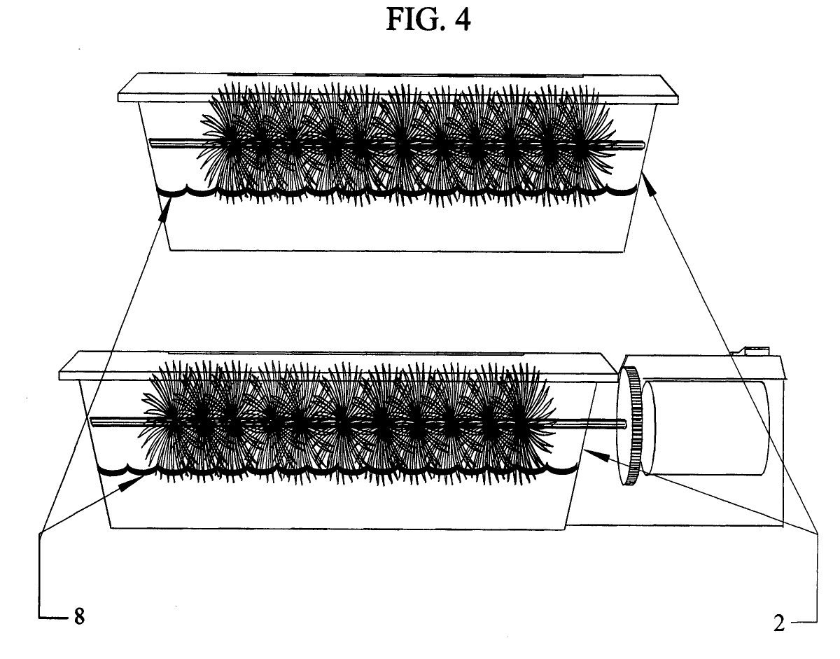

A device for pre cleaning medical and dental instruments, the device being constructed primarily of non rusting metal and or plastic. The device consists of a basin shaped container 2, abrasion elements 1 consisting of multiple bristle heads held in close proximity to each other and suspension elements or frame 3 securing the abrasion elements 1 to the bottom or sides of the container 2. The device in a manual configuration FIG. 1 has the abrasion elements 1 held stationary and suspended off the bottom of the container 2 by the suspension elements 3 so that when the user passes an instrument thru the abrasion elements 1 in a reciprocating manor, the instrument is scrubbed clean. The device in an automated configuration has gears 5 and a motor 4 with associated wiring, switches, and housings needed to operate. The abrasion elements 1 are attached to the suspension elements 3 which are used as axles and are rotated by forces generated from the motor 4 and gears 5 as seen in FIG. 2 and requires less effort by the user to scrub the instrument. A lid 6 with a small opening 7 covers the working elements of the device and deters debris loss, as seen in FIG. 3. Cleaning fluid 8 can be held within the container 2 to aid in softening and capturing debris, as seen in FIG. 4.

I claim:

1. A device for pre cleaning medical and dental instruments comprising,
multiple abrasion elements, suspension elements, and a container, said container having a basin like shape wherein said abrasion elements are secured by said suspension elements in correct position to the interior of said container, said abrasion elements being positioned in close enough proximity to each other as to contact most surfaces of an instrument that is passed thru said elements.

2. The device of claim 1 wherein said device has a motor, said motor transferring motion to said abrasion elements, causing scrubbing action to become automated.

3. The device of claim 1 wherein said device has a lid, said lid covering said device, said lid having an opening, said opening having a restricted size as to minimize debris loss without hindering instrument access to said abrasion elements within said device.

4. The device of claim 1 wherein said container is omitted, requiring said abrasion elements and suspension elements to become freestanding.
